(19) United States
(12) Patent Application Publication
(10) Pub. No.: US 2009/0022313 A1
(43) Pub. Date: Jan. 22, 2009

(54) ENCRYPTED DATA PROCESSING METHOD, ENCRYPTED DATA PROCESSING PROGRAM AND ENCRYPTED DATA PROCESSING APPARATUS

(75) Inventors: Fumihito Akiyama, Yokohama-shi (JP); Yoko Fujiwara, Kawasaki-shi (JP); Yoshinori Tanaka, Koganei-shi (JP); Masahiro Ozawa, Hino-shi (JP); Jun Kuroki, Sagamihara-shi (JP); Hiroshi Nogawa, Hachioji-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Chiyoda-ku (JP)

(21) Appl. No.: 12/104,983

(22) Filed: Apr. 17, 2008

(30) Foreign Application Priority Data
Jul. 18, 2007 (JP) 2007-186505

(51) Int. Cl. H04N 1/44

(52) U.S. Cl. 380/243

(57) ABSTRACT

An encrypted data processing method for a printing system provided with a host which transmits print data or encrypted data formed by encrypting the print data, and an image forming apparatus connected with the host via a communication network to execute printing based on the print data, the method including: a first step of determining, in the image forming apparatus, whether transmitted data from the host is the encrypted data; a second step of executing printing process in cases where the transmitted data is not the encrypted data, and decrypting the encrypted data in cases where the transmitted data is the encrypted data; and a third step of executing the printing process in cases where the decryption of the encrypted data has been successfully executed, and storing the encrypted data into a storage section in cases where the decryption has failed.

### CROSS-REFERENCE TO RELATED APPLICATION

The present application is based on Japanese Patent Application No. 2007-186505 filed with Japanese Patent Office on Jul. 18, 2007, the entire content of which is hereby incorporated by reference.

### BACKGROUND OF THE INVENTION

1. Field of the Invention

The present invention relates to an encrypted data processing method, an encrypted data processing program and an encrypted data processing apparatus to process encrypted print data.

2. Description of Related Art

In recent years, there have been proliferated in the market various kinds of copiers or multi-functional peripherals (hereinafter, generally referred to as an image forming apparatus), each provided with a combination of plural functions, such as a copy function, a facsimile function, a printer function, a scanner function, etc. When such an image forming apparatus is employed to perform a printing operation, at first, document data is created by using the application program installed in a computer apparatus connected to a communication network, after that, the created document data is converted to print data in the Page Description Language (PDL) format, and is transmitted to the image forming apparatus. After receiving the print data, the image forming apparatus converts the print data to bitmap data, and conducts printing.

In the course of transmitting the print data from the computer apparatus to the image forming apparatus, there exists the risk that the print data is illegally used in another computer apparatus connected to the communication network, therefore, the methods of transmitting the print data as an encrypted data to the image forming apparatus have been employed. For example, Unexamined Japanese Patent Application Publication No. 2004-185,566 discloses a print server apparatus including: a print data receiving means which receives the print data encrypted and attached with a user ID from a print client apparatus; a print data decrypting means to decrypt the print data; and a printer control means which allows a printing apparatus to print the print data attached with the same user ID as the user ID corresponding to user identification information stored in the card inserted in the connected card reader.

In cases where an image forming apparatus executes encrypted print data processing, conventionally employed is a method of adding a pre-data processing for discriminating if the print data is encrypted data, in addition to a normal data analysis processing such as analyzing and converting the print data of PDL format into bitmap data. For this purpose, two functions are needed for executing two separate data analysis processing. This method causes a complicated structure and raises cost of the apparatus, and further decreases processing performance of the image forming apparatus due to the complicated data analysis processing.

The present invention has been accomplished in view of the above problem, and the main object is to provide an encrypted data processing method, an encrypted data processing program and an encrypted data processing apparatus, those enabling simplified encrypted data processing.

### SUMMARY

To achieve at least one of the abovementioned objects, a method reflecting one aspect of the present invention is the method for processing encrypted data to be employed in a printing system including a host which transmits print data, or encrypted data formed by encrypting the print data, and an image forming apparatus connected with the host via a communication network to execute printing based on the print data, the method includes:

a first step of determining, in the image forming apparatus, whether transmitted data from the host is the encrypted data;

a second step of executing printing process in cases where the transmitted data is not the encrypted data, and decrypting the encrypted data in cases where the transmitted data is the encrypted data; and

a third step of executing printing process in cases where the decryption has been successfully executed, and storing the encrypted data into a storage section in cases where the decryption has failed.

In the above encrypted data processing method, it is preferable to further include:

a fourth step of reading the encrypted data from the storage section in cases where a password has been inputted;

a fifth step of decrypting the encrypted data based on the password; and

a sixth step of executing printing process in cases where the decryption in the fifth step has been successfully executed, and executing error processing incases where the decryption in the fifth step failed.

In the above encrypted data processing method, it is preferable to have a configuration where, in the first step, whether the transmitted data is the encrypted data is determined based on whether a specific keyword is included in the transmitted data.

### BRIEF DESCRIPTION OF THE DRAWINGS

These and other objects, advantages and features of the invention will become apparent from the following description thereof taken in conjunction with the accompanying drawings in which:

FIG. 1 is a schematic view showing a configuration of a printing system relating to an embodiment of the present invention;

FIG. 2 is a block diagram showing a configuration of a printing system (specifically, the control section of the image forming apparatus) relating to an embodiment of the present invention;

FIG. 3 is a diagram showing a configuration of an image forming apparatus relating to an embodiment of the present invention;

FIG. 4 is a diagram showing block configurations and an outline of the processing of the printing system relating to an embodiment of the present invention;

FIG. 5 is a flow chart showing the processing at the time of storing encrypted data in the image forming apparatus relating to an embodiment of the present invention;

FIG. 6 is a flow chart showing the processing at the time of printing the encrypted data in the image forming apparatus relating to an embodiment of the present invention;

FIG. 7 shows configuration example of the encrypted data relating to an embodiment of the present invention;

FIG. 8 shows an example of specifying a password relating to an embodiment of the present invention;

FIG. 9 shows block configurations and a processing outline of the conventional printing system;

FIG. 10 is a flow chart showing the processing at the time of storing encrypted data in the conventional image forming apparatus; and

FIG. 11 is a flow chart showing the processing at the time of printing the encrypted data in the conventional image forming apparatus.

### DETAILED DESCRIPTION OF THE PREFERRED EMBODIMENTS

As explained in the description of the related art, in order to prevent illegal use of print data, a method is conventionally employed where a computer apparatus transmits encrypted data, formed by encrypting the print data, and in an image forming apparatus, the transmitted data is determined if it is encrypted data, and in the case of encrypted data, a password for decryption is inputted, and in cases where correct password is inputted, the printing process is executed.

In the abovementioned conventional method, generally employed are: pre-data analysis processing to determine, before the usual data analysis processing in a data analysis section, if the transmitted data is encrypted data; storing processing to store the data, in the case of encrypted data, into a storage section such as an HDD; and decrypting processing to decrypt the encrypted data based on the password inputted through an operation section such as an operation panel. Namely, for the data analysis processing, prerequisite is that the encrypted data and the correct password are inputted as a combination, and if the correct password is not inputted, it is determined to be an analysis error and terminated as an error termination. Therefore, the pre-data analysis processing is necessary, which is required of the same level of data analysis processing as that of normal data analysis processing. This method causes problems of a complicated structure and cost-up of the apparatus, and decreases processing performance of the image forming apparatus due to the complicated data analysis processing.

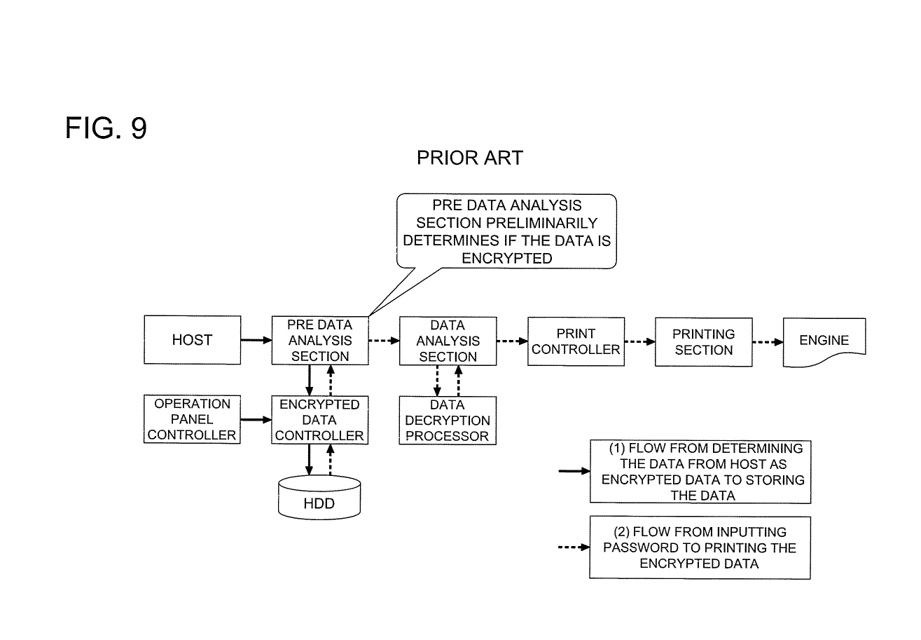

To be more specific, as shown in FIG. 9, the conventional image forming apparatus is provided with: a pre-data analysis section which performs the same level of data analysis processing as that of normal data analysis processing to determine if the transmitted data from the host is encrypted; an encrypted data controller to control storage/retrieval of the encrypted data; a data decryption processor to decrypt the encrypted data based on the inputted password; a data analysis section to analyze the decrypted data, to convert the print data in the PDL format into bitmap data, and to send a print request to a print controller; an operation panel controller to control the operation panel; a print controller to process a generated event of print processing; a printing section to convert the bitmap data into video signals and to output the data; and an engine to execute printing based on the video signals.

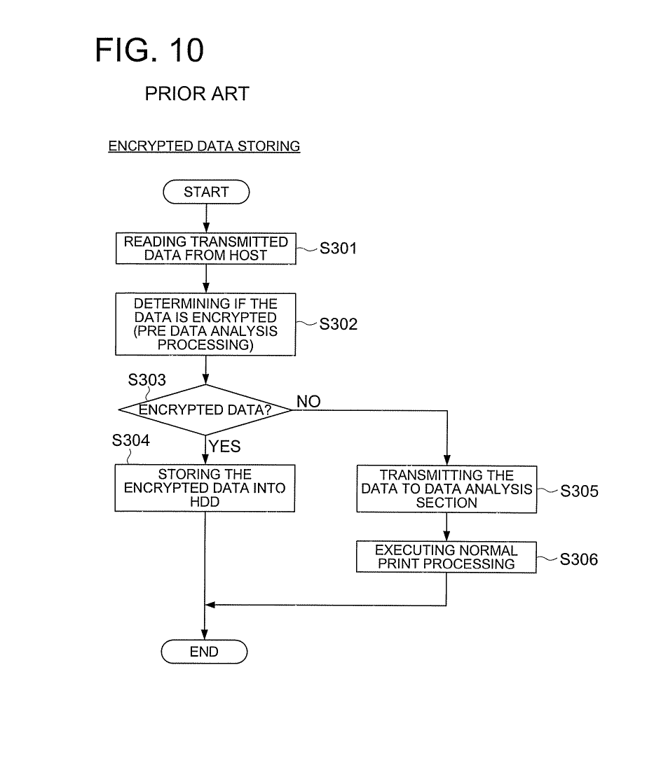

In the conventional process, when the transmitted data from the host is inputted, as shown by solid bold arrows in FIG. 9 and by the flow chart of FIG. 10, the transmitted data from the host is read (Step S301), the pre-data analysis section performs pre-decoding (the same level of analysis processing as that of the normal analysis processing) and determines if the transmitted data is encrypted data (Step S302). Then, in cases where the transmitted data is encrypted data (Yes, in Step S303), the encrypted data controller stores the encrypted data into a storage section such as an HDD (Step S304). In cases where the transmitted data is not encrypted (No, in Step S303), the transmitted data is sent to a data analysis section (Step S305), and the data analysis section converts the transmitted data into bitmap data and issues a print request to a print controller, and then, a printing section converts the bitmap data into video signals and outputs them to the engine to execute normal print processing (Step S306).

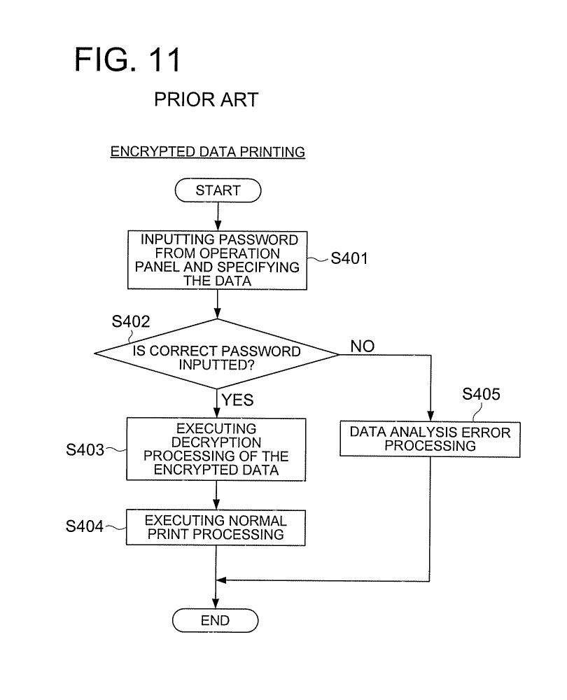

Further, in the case of printing the encrypted data in the conventional process, as shown by bold dashed allows in FIG. 9 and by the flow chart of FIG. 11, when a password is inputted and data is specified from the operation panel (Step S401), the data analysis section determines whether the correct password was inputted (Step S402), and in cases where the correct password was not inputted (No, in Step S402) the data analysis section executes an error processing (Step S405), in cases where the correct password was inputted (Yes, Step S402) calls for a data decryption processor to execute decryption processing (Step S 403), and converts the print data into bitmap data and issues a print request to a print controller, and the printing section converts the bitmap data into video signals to output onto the engine for executing normal printing processing (Step S404).

According to such configuration that the pre-decoding (processing for determining whether the data is encrypted) in the pre-data analysis section, and the data analysis in the data analysis section are separately executed, the apparatus structure and the data analysis processing become complicated. In the present invention, however, executed steps are: determining in the data analysis section whether the transmitted data is encrypted based on whether a specific keyword is incorporated in the transmitted data; in the case of encrypted data, decrypting the encrypted data in a data decrypting processor; in the case of successful decryption, executing the printing processing; in a case of failed decryption, determining that the data requires a password input and allowing the encrypted data controller to store the encrypted data into the storage section. Further, in the case that the password is inputted, the data analysis section, allows the data decrypting processor to decrypt the encrypted data stored in the storage section, executes printing processing when successfully decrypted, and executes error processing when the decryption failed. According to this method, since the pre-data analysis processing in the pre-data analysis section can be omitted, the apparatus structure as well as the encrypted data processing can be simplified compared to the conventional method.

### EMBODIMENT

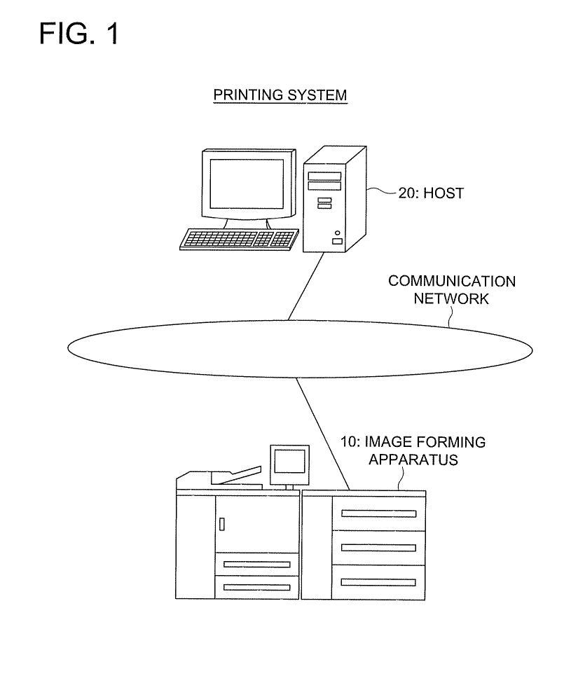

In order to explain the above described embodiment of the present invention in more detail, the encrypted data processing method, the encrypted data processing program and the encrypted data processing apparatus relating to the present invention will be described referring to FIGS. 1 to 8.

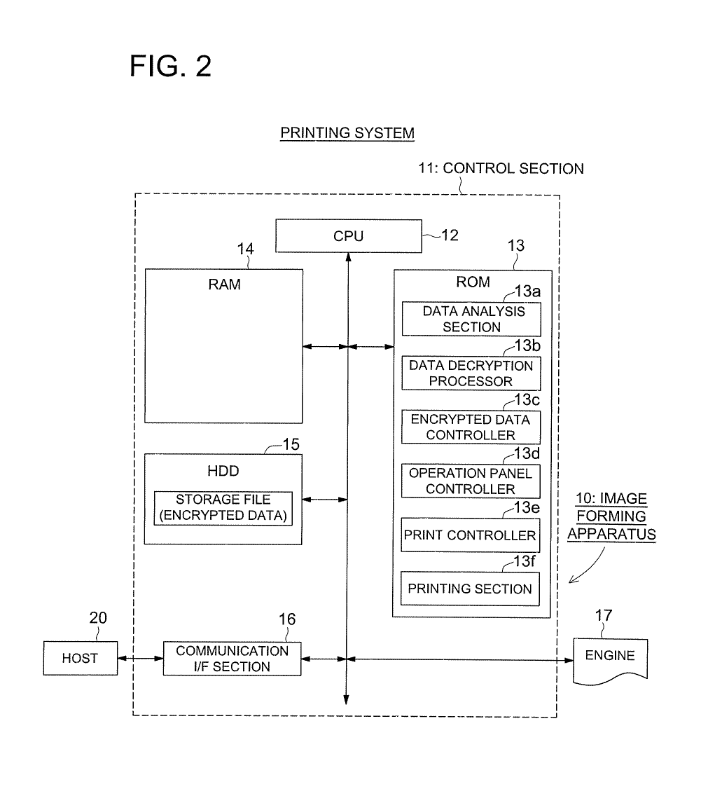

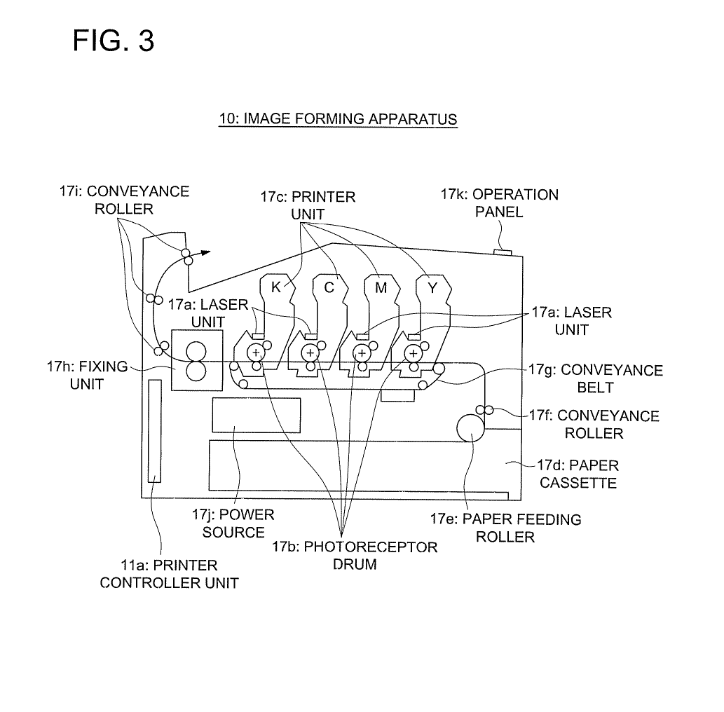

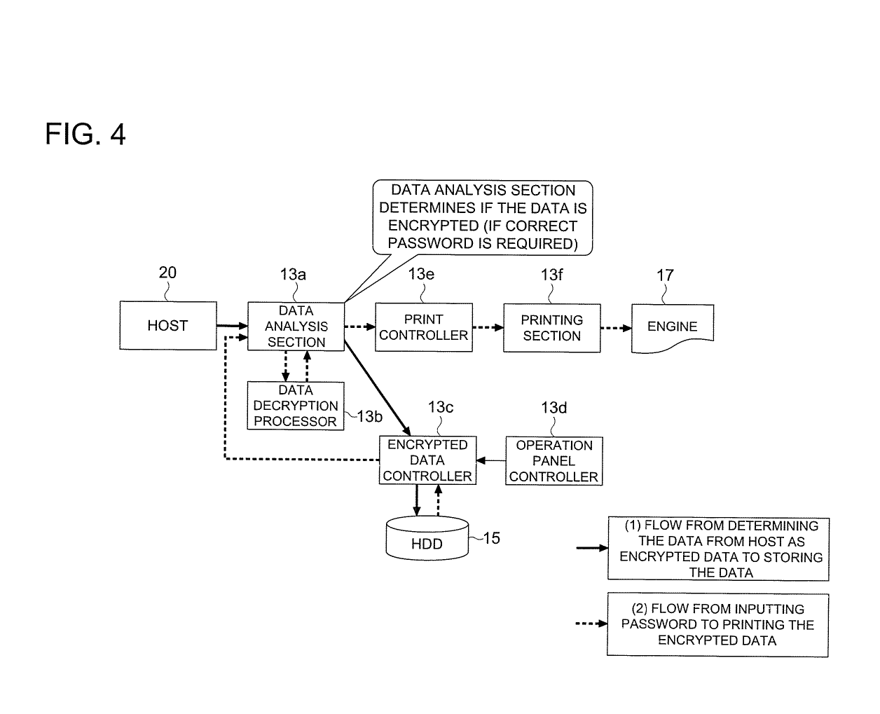

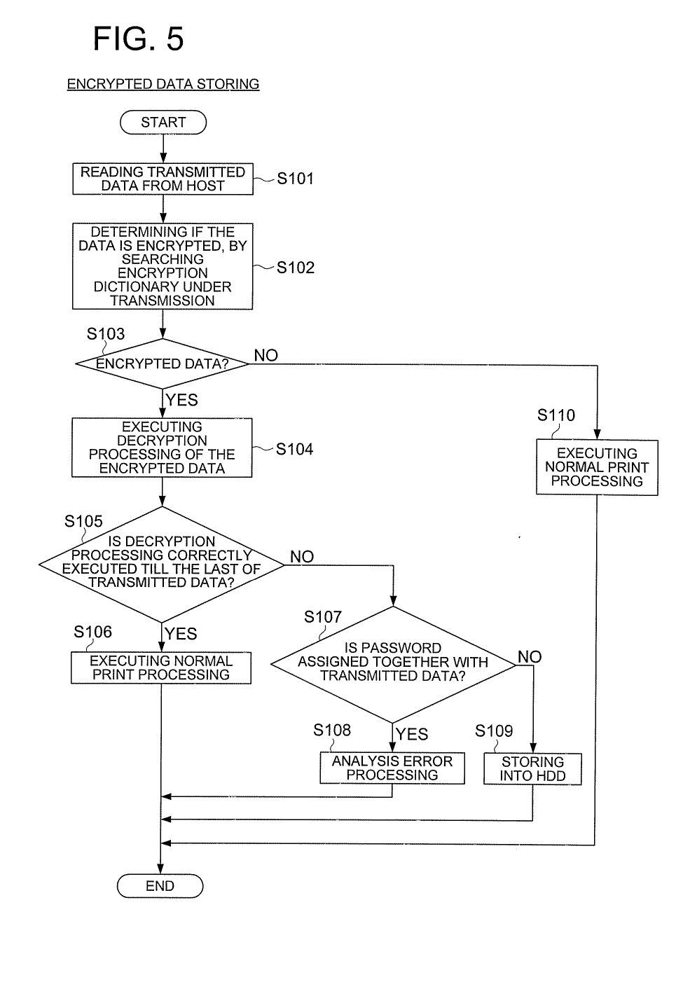

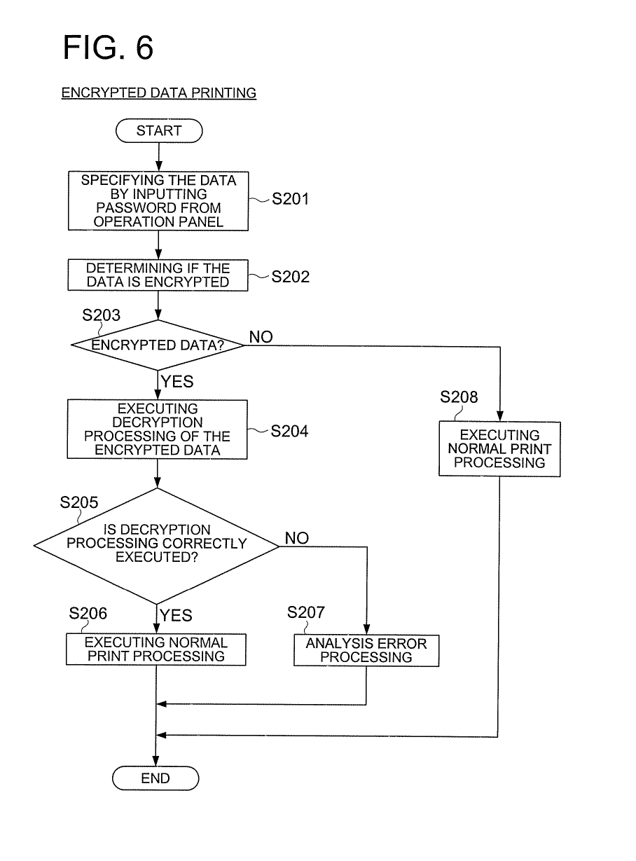

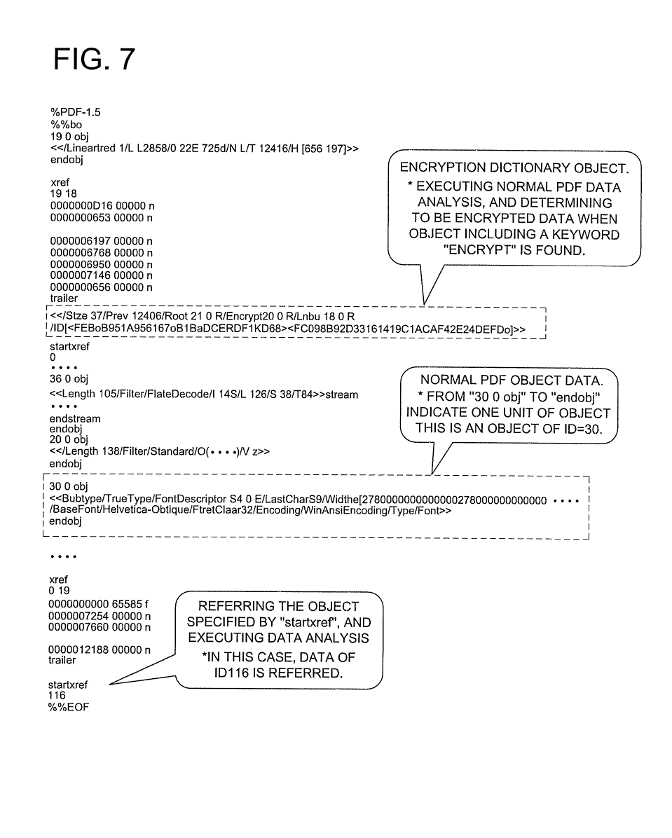

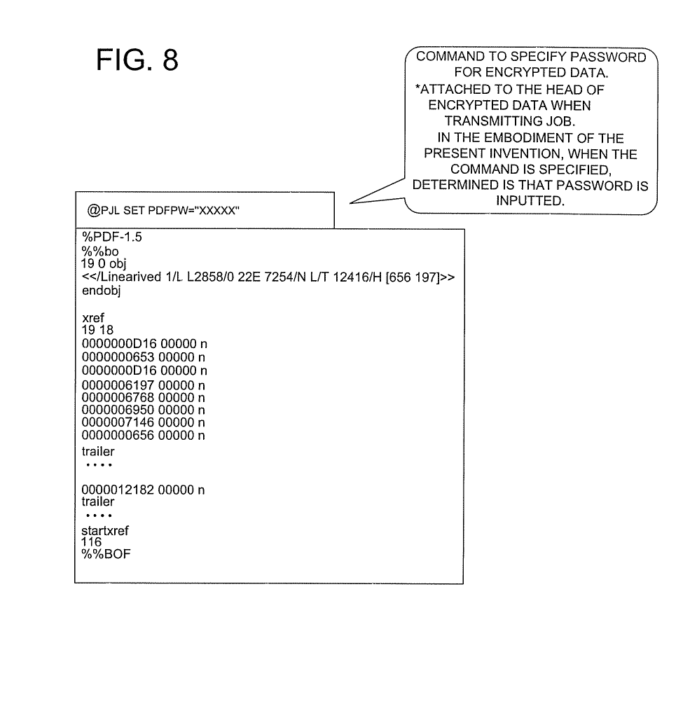

FIG. 1 is a schematic view showing a configuration of a printing system relating to an embodiment of the present invention. FIG. 2 is a block diagram showing a configuration of a printing system (specifically, the control section of the image forming apparatus), and FIG. 3 is a diagram showing a concrete configuration of an image forming apparatus. FIG. 4 is a diagram showing block configurations and an outline of the processing of the printing system, FIG. 5 is a flow chart showing the processing at the time of storing encrypted data, FIG. 6 is a flow chart showing the processing at the time of printing the encrypted data, FIG. 7 shows configuration example of the encrypted data, and FIG. 8 shows an example of specifying a password.

As shown in FIG. 1, a printing system of the present embodiment comprises one or more computer apparatus (hereinafter referred to host 20) which instruct print processing based on PDL format data (hereinafter referred to print data) converted from document data formed by a document application, or encrypted data formed by encrypting the print data (hereinafter referred to encrypted data); and one or more image forming apparatus 10 such as a printer and a digital multifunctional peripheral which receives the print data or the encrypted data transmitted from host 20 (these are commonly referred to transmitted data), decrypts the encrypted data, and converts the print data into bitmap data to execute printing. And host 20 and image forming apparatus 10 are connected via a communication network such as LAN (Local Area Network) or WAN (Wide Area Network).

Although, in FIG. 1, shown is a case where image forming apparatus 10 is assumed as an encrypted data processing apparatus, another case is possible where a RIP (Raster Image Processor) server is connected to the network and the RIP server is assumed to be the encrypted data processing apparatus, and image forming apparatus 10 executes the printing based on video signals outputted from the RIP server. Further, although in a configuration of the present embodiment, a printer driver in host 20 converts the document data into print data of PDL format, in the case where the document data is described with a file format, such as XSP (XML Paper Specification) and PDF (Portable Document Format), those being compatible to direct print, it is not necessary to convert the document data into PDL format, and the document data is directly applicable as the print data.

As shown in FIG. 2, image forming apparatus 10 comprises CPU (Central Processing Unit) 12, ROM (Read Only Memory) 13, RAM (Random Access Memory) 14, HDD (hard Disk Drive) 15, control section 11 including NIC (Net Work Interface Card) for connecting to a communication network, an operation panel for conducting display and input operation of various kind of information, communication I/F section such as a modem, and engine 17 such as a printer section to execute print processing. In Rom 13, stored are programs of data analysis section 13a, data decryption processor 13b, encrypted data controller 13c, operation panel controller 13d, print controller 13e, and print section 13f, while these programs are read into RAM 14 and executed on CPU 12.

Data analysis section 13a, in addition to execute normal data analysis processing for analyzing print data of PDL format and converting into bitmap data, determines whether the transmitted data is encrypted data based on whether a specific keyword (for example, an Encryption Dictionary object in case of PDF) is included in the transmitted data from host 20. In a case of not encrypted, data analysis section 13a issues a print request to print controller 13e, and in a case of encrypted data, calls data decryption processor 13b and allows the encrypted data to be decrypted, and in cases where data decryption processor 13b failed in decryption processing, allows encrypted data controller 13c to store the encrypted data into HDD 15.

Data decryption processor 13b executes processing of decrypting the encrypted data based on a predetermined table by the instruction of data analysis section 13a.

Encrypted data controller 13c stores the encrypted data into the storage section such as HDD according to the instruction of data analysis section 13a, and receiving an input of password from operation panel controller, transmits the stored encrypted data together with the password onto data analysis section 13a.

Operation panel controller 13d allows the operation panel to display a screen for requesting a password input, and transmits the inputted password onto encrypted data controller 13c.

Print controller 13e processes a generated event of print processing based on the print request from data analysis section 13a. Print controller 13e executes control of print operation, for example, allowing engine 17 to start printing and performing error processing.

Printing section 13f converts the bitmap data into video signals and outputs to engine 17, and allows engine 17 (printer section) to conduct printing.

In FIG. 2, a configuration is shown where data analysis section 13a, data decryption processor 13B, encrypted data controller 13c, operation panel controller 13d, print controller 13e, and print section 13f, are structured as respective programs and stored in ROM 13, however, these may be structured as hardware. Further, since the configuration shown in FIG. 2 is only exemplified, for example, data analysis section 13a and data decryption processor can be combined to allow data analysis section to have also the function of data decryption processor, and print controller 13e and printing section can be combined to allow print controller 13e to convert the bitmap data into video signals to output.

Although, concrete structure of image forming apparatus 10 is not specifically restricted, a structure shown in FIG. 3 may be possible. In the structure of FIG. 3, printer controller unit 11a functions as control section 11 of FIG. 2, and converts the print data transmitted from host 20 into video signals to output to laser unit 17a. Laser unit 17a emits laser beams according to the video signals to form electrostatic latent image on photo receptor drum 17b. This latent image is developed by printer unit 17c and transferred onto a recording sheet. The recording sheet is stored in paper cassette 17d, and after picked up by paper feeding roller 17e, conveyed by conveyance roller 17f and conveyance belt 17g, and transferred with the developed image. The transferred image is fixed by fixing unit 17h and ejected by conveyance rollers 17i. Power source 17j supplies power to the apparatus. Herein, a configuration including drums of four colors YMCK (tandem system) is shown, however, a configuration having one photoreceptor drum (one drum system) is also applicable.

Next, processing procedure of the encrypted data in the above image forming apparatus 10 will be described by referring to a block diagram of FIG. 4 and flow charts of FIGS. 5 and 6.

The processing procedure at the time of storing encrypted data is shown by bold solid allows in FIG. 4 and the flow chart in FIG. 5. At first, host 20 generates document data by the use of document application, and in necessary, encrypts the document data by using a function previously provided to the document application to form encrypted data, and transmits this document data or the encrypted data via the communication network onto image forming apparatus 10. Although the type of this document data is not particularly restricted, in the case of PDF format data for example, the encrypted data is described as shown in FIG. 7 to include an encryption dictionary object having a keyword of “/Encrypt”, and at the top of the encrypted data, added is a password specifying command such as {@PJL SET PDFPW=“XXX”} as shown in FIG. 8.

Next, in Step S101, image forming apparatus 10 receives the transmitted data through communication I/F section 16 from host 20, and sends the transmitted data to data analysis section 13a.

In the conventional image forming apparatus, the transmitted data is sent to pre-data analysis section, and the pre-data analysis section executes the same level of analysis processing as the normal data analysis processing to determine whether the transmitted data is encrypted, however, in image forming apparatus 10 of the present embodiment, data analysis section 13a determines whether the transmitted data is encrypted based on whether a specific keyword is included in the transmitted data in Step S102. For example, in cases where the transmitted data is PDF data as shown in FIG. 7, data analysis section 13a executes a usual PDF data analysis (referring to object), and searches the object having the keyword of “/Encrypt”.

Then, in cases where the transmitted data is not an encrypted data (namely, the specific keyword is not included), since there is no need to decrypt the transmitted data, in Step S110, data analysis section 13a analyzes the print data and converts into bitmap data, and issues print request to print controller 13e, and print controller 13e executes an event processing, printing section 13f converts the bitmap data to video signals and outputs onto engine 17 to allow engine 17 to execute printing.

Meanwhile, in cases where the transmitted data is encrypted (namely, the specific keyword is included), in Step S104, data analysis section 13a calls data decryption processor 13b and allows data decryption processor 13b to execute decryption processing.

Then, in cases where the decryption processing has been correctly executed until the last of the transmitted data (Yes, step S105), in Step S106, data analysis section 13a converts the decrypted print data into bitmap data, and issues print request to print controller 13e. The print controller 13e executes event processing, and printing section 13f converts the bitmap data into video signals to output to engine 17, and allows engine 17 to execute printing.

In contrast, in cases where the decryption processing has not been correctly executed (No, in step S105), data analysis section 13a determines, in Step S107, whether the password is specified with the transmitted data, and if the decryption processing is failed even when the password is specified, processes as an analysis error (incorrect password) in Step S108.

Further, when the password is not specified, since it can be determined that the decryption processing has failed because the password is not specified, data analysis section 13a does not invoke error termination, but determines the transmitted data to be the encrypted data requiring a password, and in Step S109 allows encrypted data controller 13c to store the encrypted data into HDD15.

The processing procedure at the time of printing the encrypted data is shown by bold dashed allows in FIG. 4 and the flow chart in FIG. 6. At first, operation panel controller 13d allows the operation panel to display a password input screen, and in Step S201, when a user operates the operation panel to input the password and specifies the data to be printed, data analysis section 13a determines whether the specified data is encrypted data in Step S 202. Specifically, similarly to Step S103 in FIG. 5, data analysis section 13a determines whether the data is encrypted based on whether the specific keyword is included in the specified data.

And, in cases where the specified data is not encrypted data (in the case of No, in Step S203), since there is no need to decrypt the transmitted data, in Step S208, data analysis section 13a converts the specified data (print data) into bitmap data and issues print request to print controller 13e, print controller 13e executes an event processing, and printing section 13f converts the bitmap data to video signals and outputs onto engine 17 to allow engine 17 to execute printing.

Meanwhile, in cases where the specified data is encrypted data (in the case of Yes in step S203), in Step S204, data analysis section 13a calls data decryption processor 13b and allows data decryption processor 13b to execute decryption processing.

Then, in cases where the decryption processing has been correctly executed until the last of the transmitted data (Yes, in Step S205), in Step S206 data analysis section 13a converts the decrypted print data into bitmap data, and issues print request to print controller 13e. The print controller 13e executes event processing, and printing section 13f converts the bitmap data into video signals to output to engine 17 and allows engine 17 to execute printing.

In contrast, in cases where the decryption processing has not been correctly executed (No, in Step S205), data analysis section 13a determines, in step S207, since the decryption processing failed even when the password is specified, processes as an analysis error (incorrect password) in Step S207.

As described above, in the present embodiment, the data analysis section 13a, which conducts normal data analysis processing to analyze and convert the print data into bitmap data, determines whether the transmitted data is encrypted based on whether a specific keyword is incorporated in the transmitted data from host 20; and in cases where the transmitted data is encrypted data, allows data decrypting processor 13b to decrypt the encrypted data; in cases of failed decryption, determines that the data requires a password input and allows the encrypted data controller 13c to store the encrypted data into the storage section. Therefore, compared to the conventional image forming apparatus provided with a pre-data analysis section, the apparatus structure as well as the encrypted data processing can be simplified due to omission of the pre-data analysis processing.

Although, in the above-described embodiment, the case is shown where the transmitted data is analyzed in image forming apparatus 10, the present invention should not be restricted to this embodiment. The present invention is applicable to cases where the other apparatus such as RIP server conducts the transmitted data analysis.

The present invention is applicable to an encrypted data processing method, an encrypted data processing program, and an encrypted data processing apparatus.

What is claimed is:

1. An encrypted data processing method for a printing system comprising a host which transmits print data or encrypted data formed by encrypting the print data, and an image forming apparatus connected with the host via a communication network to execute printing based on the print data, the method comprising:
a first step of determining, in the image forming apparatus, whether transmitted data from the host is the encrypted data;
a second step of executing printing process in cases where the transmitted data is not the encrypted data, and decrypting the encrypted data in cases where the transmitted data is the encrypted data; and
a third step of executing the printing process in cases where the decryption of the encrypted data has been successfully executed, and storing the encrypted data into a storage section in cases where the decryption has failed.

2. The encrypted data processing method of claim 1, further comprising:
a fourth step of reading out the encrypted data from the storage section in cases where a password has been inputted;
a fifth step of decrypting the encrypted data based on the password; and
a sixth step of executing the printing process in cases where the decryption of the encrypted data in the fifth step has been successfully executed, and executing error processing in cases where the decryption in the fifth step has failed.

3. The encrypted data processing method of claim 1, wherein whether the transmitted data is the encrypted data is determined, in the first step, based on whether a specific keyword is included in the transmitted data.

4. A computer-readable storage medium stored therein an encrypted data processing program which operates on an image forming apparatus or a RIP server each connected via a communication network to a host which transmits print data or encrypted data generated by encrypting the print data, the program causes a computer to have functions of:
a data analysis section which analyzes the print data and instructs printing;
a data decryption processor which decrypts the encrypted data; and
an encrypted data controller which stores the encrypted data into a storage section, and reads out the encrypted data in cases where a password has been inputted,
wherein the data analysis section determines whether transmitted data from the host is the encrypted data, and in cases where the transmitted data is the encrypted data, allows the data decryption processor to decrypt the encrypted data, and in cases where decryption of the encrypted data has been successfully executed, analyzes the print data and instructs printing, and in cases where the decryption of the encrypted data has failed, allows the encrypted data controller to store the encrypted data into the storage section.

5. The computer-readable storage medium of claim 4, wherein the data analysis section allows the data decryption processor to decrypt the encrypted data stored in the storage section based on the password, and in cases where the decryption of the encrypted data has been successfully executed, analyzes the print data and instructs printing, and in cases where the decryption of the encrypted data has failed, executes an error processing.

6. The computer-readable storage medium of claim 4, wherein the data analysis section determines whether the transmitted data is the encrypted data, based on whether a specific keyword is included in the transmitted data.

7. An encrypted data processing apparatus connected via a communication network to a host which transmits print data or encrypted data generated by encrypting the print data, comprising:
a data analysis section which analyzes the print data and instructs printing;
a data decryption processor which decrypts the encrypted data; and
an encrypted data controller which stores the encrypted data into a storage section, and reads out the encrypted data in cases where a password is inputted,
wherein the data analysis section determines whether transmitted data from the host is the encrypted data, and in cases where the transmitted data is the encrypted data, allows the data decryption processor to decrypt the encrypted data, and in cases where decryption of the encrypted data has been successfully executed, analyzes the print data and instructs printing, and in cases where the decryption of the data has failed, allows the encrypted data controller to store the encrypted data into the storage section.

8. The encrypted data processing apparatus of claim 7, wherein the data analysis section allows the data decryption processor to decrypt the encrypted data stored in the storage section based on the password, and in cases where the decryption of the encrypted data has been successfully executed, analyzes the print data and instructs printing, and in cases where the decryption of the encrypted data has failed, executes and error processing.

9. The encrypted data processing apparatus of claim 7, wherein the data analysis section determines whether the transmitted data is the encrypted data, based on whether a specific keyword is included in the transmitted data.
